(19) United States
(12) Patent Application Publication
(10) Pub. No.: US 2017/0131792 A1
(43) Pub. Date: May 11, 2017

(54) REMOTE OPERATION DEVICE

(71) Applicant: DENSO CORPORATION, Kariya-city, Aichi-pref. (JP)

(72) Inventor: Kazumi HAYASHI, Kariya-city (JP)

(21) Appl. No.: 15/119,580

(22) PCT Filed: Feb. 13, 2015
(86) PCT No.: PCT/JP2015/000663

§ 371 Date: Aug. 17, 2016

(30) Foreign Application Priority Data
Feb. 21, 2014 (JP) 2014-031712

(51) Int. Cl. G06F 3/0338; G06F 3/0362; G06F 3/02; B60K 37/06; G06F 3/0354

(52) U.S. Cl. CPC G06F 3/0338; B60K 37/06; G06F 3/03547; G06F 3/0202; G06F 3/0362; B60K 2350/1028; B60K 2350/1076; B60K 2350/104

(57) ABSTRACT

A remote operation device includes a first operation acceptance portion provided as a mechanism to accept an operation from an outside and having a rotary dial supported in a displaceable and rotatable manner, a second operation acceptance portion formed of a touch panel provided on an outer surface of the rotary dial, and a control portion. The control portion accepts displacement of the rotary dial from a preliminarily determined neutral position as one operation from the outside, accepts a rotation angle of the rotary dial as one operation from the outside, and accepts an operation on the second operation acceptance portion as one operation from the outside. The control portion operates an in-vehicle device by remote control by transmitting contents of accepted operations to the in-vehicle device.

### CROSS REFERENCE TO RELATED APPLICATION

This application is based on Japanese Patent Application No. 2014-31712 filed on Feb. 21, 2014, the disclosure of which is incorporated herein by reference.

### TECHNICAL FIELD

The present disclosure relates to a remote operation device to operate a device installed to a mobile body by remote control.

### BACKGROUND ART

A remote operation device in the related art enables a user to operate an in-vehicle device installed to an automobile by remote control without directly touching the in-vehicle device (see Patent Literature 1).

The remote operation device as above includes an operation acceptance portion accepting an operation from an outside and a control portion controlling the in-vehicle device according to an operation accepted in the operation acceptance portion. The operation acceptance portion has a rotary disc which is attached at a tip end of a tiltable and rotatable support shaft and therefore tilts and rotates integrally with the support shaft. In other words, the operation acceptance portion of the remote operation device in the related art has a first input system to accept tilting (displacement) of the rotary disc as an operation from the outside and a second input system to accept a rotation operation on the rotary disc as an operation from the outside.

### PRIOR ART LITERATURE

### Patent Literature

Patent Literature 1: JP 2013-098133 A

### SUMMARY OF INVENTION

In the remote operation device in the related art, input systems of information necessary to operate the in-vehicle device are as few as two, that is, only the first input system and the second input system. Hence, when a device installed to the automobile increases in variety or in number, the user has to repeat same operations by using the remote operation device in the related art to operate the respective in-vehicle devices by remote control. The remote operation device in the related art therefore has a drawback that operations require more time and labor.

In other words, the remote operation device in the related art has a drawback that the variety of information that can be inputted via the operation acceptance portion and hence via the rotary disc is limited.

The present disclosure has an object to provide a remote operation device capable of increasing the variety of information that can be inputted via the rotary disc.

A remote operation device according to an aspect of the present disclosure is attached to an attached portion, which is a predetermined portion of a mobile body, and configured to operate a device installed to the mobile body by remote control.

The remote operation device includes an operation acceptance portion, a palm rest portion, and a control portion.

The operation acceptance portion is a mechanism to accept an operation from an outside and has a rotary disc supported in a displaceable and rotatable manner. The palm rest portion extends from the attached portion so as to cover at least a part of the rotary disc. The control portion transmits information corresponding to an operation from the outside and accepted in the operation acceptance portion to at least the installed device.

The operation acceptance portion includes an internal operation mechanism, a first input portion, a second input portion, and a third input portion.

The internal operation mechanism has an input acceptance mechanism provided on an outer surface of the rotary disc. The first input portion accepts displacement of the rotary disc from a preliminarily determined neutral position as one operation from the outside. The second input portion accepts a rotation angle of the rotary disc as one operation from the outside. The third input portion accepts an operation on the internal operation mechanism as one operation from the outside.

According to the remote operation device configured as above, the input system of information necessary to operate the in-vehicle device can be increased to three, that is, the input systems for displacement of the rotary disc itself from the neutral position, a rotation angle of the entire rotary disc, and an operation on the internal operation mechanism.

Consequently, the variety of information that can be inputted via the rotary disc can be increased.

Hence, according to the remote operation device configured as above, even when the installed device is increased in variety or in number, same operations a user has to repeat by using the rotary disc to operate the respective installed devices can be reduced. In short, time and labor required for operations can be reduced by the remote operation device configured as above.

### BRIEF DESCRIPTION OF DRAWINGS

The above and other objects, features and advantages of the present disclosure will become more apparent from the following detailed description made with reference to the accompanying drawings, in which:

FIG. 1 is a perspective view showing an outer appearance of a remote operation device according to one embodiment of the present disclosure;

FIG. 2 is a schematic sectional view taken along the line II-II of FIG. 1;

FIG. 3 is a block diagram of a control system of the remote operation device;

FIG. 4 is a flowchart depicting a processing procedure of input acceptance processing performed by a control portion of the remote operation device;

FIG. 5A is a view used to describe an example of an operation of the remote operation device;

FIG. 5B is a view used to describe another example of an operation of the remote operation device;

FIG. 5C is a view used to describe a further example of an operation of the remote operation device;

FIG. 5D is a view used to describe still another example of an operation of the remote operation device;

FIG. 6A is a view of a modification of the remote operation device;

FIG. 6B is a view of another modification of the remote operation device;

FIG. 7 is a flowchart depicting input acceptance processing according to a modification performed by the control portion;

FIG. 8 is a flowchart depicting input acceptance processing according to another modification performed by the control portion;

FIG. 9A is a view of a modification of the remote operation device;

FIG. 9B is a view of another modification of the remote operation device;

FIG. 9C is a view of still another modification of the remote operation device;

FIG. 10A is a schematic sectional view of a modification of a second operation acceptance portion to show an unlocked state; and

FIG. 10B is a partial sectional view of a portion XB in the modification of the second operation acceptance portion shown in FIG. 10A to show a locked state.

### DESCRIPTION OF EMBODIMENTS

Hereinafter, embodiments of the present disclosure will be described with reference to the drawings.

### Remote Operation Device

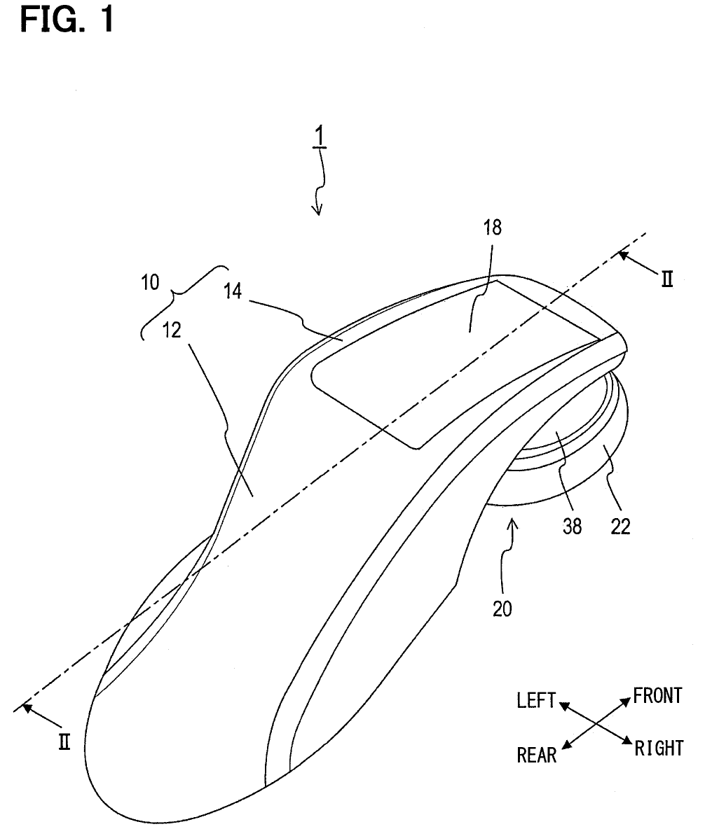

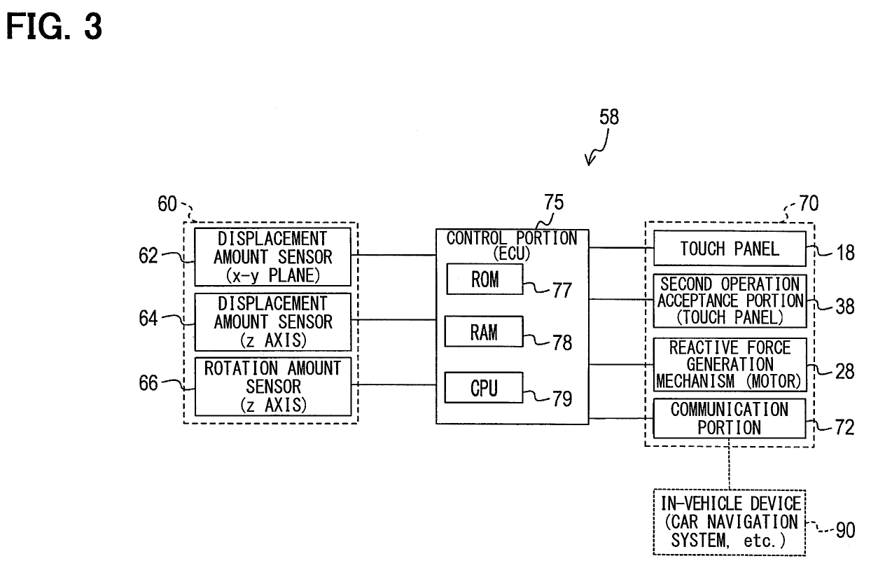

A remote operation device 1 shown in FIG. 1 is a device to enable a user to operate an in-vehicle device 90 (see FIG. 3) installed to an automobile by remote control without directly touching the in-vehicle device 90. The in-vehicle 90 referred to herein is an example and includes various types of devices installed to an automobile. The in-vehicle device 90 can be, for example, an in-vehicle navigation system (so-called car navigation system) that guides the user along a route to a destination, an air conditioner (in-vehicle air conditioner) that adjusts a temperature in a vehicle interior, and an audio instrument.

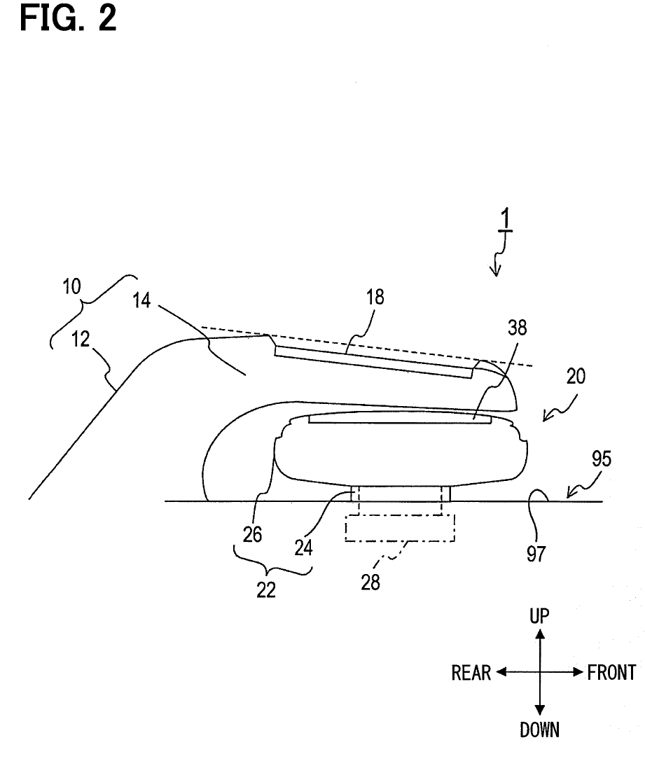

The remote operation device 1 is attached to a predetermined portion (hereinafter, referred to as an attached portion) 95 (see FIG. 2) of the automobile. For example, the attached portion 95 of the present embodiment is on top of a console provided between a driver's seat and a front passenger's seat in the vehicle interior.

The remote operation device 1 includes a palm rest 10, an input mechanism 20, and a control system 58 (see FIG. 3).

The palm rest 10 is a portion on which the user rests his hand. The input mechanism 20 accepts inputs of various types of information necessary to control the in-vehicle device 90. The control system 58 outputs various types of information inputted via the input mechanism 20 to the in-vehicle device 90 and operates the in-vehicle device 90 by remote control.

The palm rest 10 is a tongue-like member extended from the attached portion 95, and includes an upward extending portion 12 and a forward extending portion 14. In the palm rest 10 of the present embodiment, the upward extending portion 12 and the forward extending portion 14 are provided as an integral unit.

The upward extending portion 12 is a pillar-like portion protruding upward in a vehicle height direction from the attached portion 95. The forward extending portion 14 is a plate-like portion extending forward along a full-length direction of the automobile from an end of the upward extending portion 12 on an opposite side to the attached portion 95. The forward extending portion 14 extends substantially parallel to an attached surface 97 of the attached portion 95. An open space is thus formed between the forward extending portion 14 and the attached surface 97 of the attached portion 95.

A touch panel 18 is provided on a top surface of the palm rest 10. The touch panel 18 is a known capacitance touch panel and configured to detect a position the user is touching with his finger. The touch panel 18 of the present embodiment is an example of a second panel mechanism.

### Input Mechanism

The input mechanism 20 is a known mechanism to accept an input from the outside and, as is shown in FIG. 2, disposed in the open space formed between the forward extending portion 14 of the palm rest 10 and the attached surface 97 of the attached portion 95. The input mechanism 20 includes a first operation acceptance portion 22 and a second operation acceptance portion 38.

The first operation acceptance portion 22 has a support shaft 24 and a rotary dial 26.

The support shaft 24 is a shaft protruding from inside the remote operation device 1 and allowed to tilt in at least eight directions with respect to one end as a base point. The eight directions are front, rear, left, and right directions and respective midway directions.

The rotary dial 26 is formed in a circular shape having a diameter longer than the forward extending portion 14 of the palm rest 10 in a vehicle width direction. The rotary dial 26 is a rotary disc which is attached to the support shaft 24 at an end opposite to the one end as the base point of tilting and therefore tilts and rotates integrally with the support shaft 24. The rotary dial 26 of the first operation acceptance portion 22 of the present embodiment is allowed to rotate within a predetermined angle range (for example, from −15 degrees to +15 degrees) with respect to a reference axis preliminarily determined along the full-length direction of the automobile.

In other words, the first operation acceptance portion 22 is a known operation lever to accept displacement from a neutral position preliminarily determined in the attached portion 95 as an input from the outside. The first operation acceptance portion 22 is of a known configuration as described in, for example, JP 2013-98133 A, the disclosure of which is incorporated herein by reference. A detailed description of the configuration is therefore omitted herein.

The phrase, “displacement from the neutral position”, referred to herein includes displacement due to tilting, displacement due to pressing, and displacement due to a rotation about an axis.

The phase, “displacement due to tilting”, referred to herein is a tilt of the first operation acceptance portion 22 from the neutral position in the attached surface 97 (that is, an x-y plane) of the attached portion 95. That is to say, the first operation acceptance portion 22 of the present embodiment accepts a direction (tilt direction) in which the first operation acceptance portion 22 itself has tilted and an amount of the tilt (tilt amount) as an input from the outside. The tilt direction referred to in the present embodiment includes at least eight directions: the full-length direction (front and rear directions) of the automobile, the vehicle width direction (left and right directions) of the automobile, and respective midway directions.

The first operation acceptance portion 22 of the present embodiment is configured to tilt step by step by a preliminarily determined amount at a time from the neutral position in the x-y plane.

The phrase, “displacement due to pressing”, referred to herein is downward displacement along the vehicle height direction of the automobile (that is, a z axis). The phrase, “displacement due to a rotation about the axis”, referred to herein is a rotation angle produced when the rotary dial 26 rotates about an axis (that is, the support shaft 24 (z axis)) along the vehicle height direction of the automobile as a center of rotation.

The remote operation device 1 further includes a reactive force generation mechanism 28 that applies a force to the support shaft 24 and the rotary dial 26 with the purpose of enhancing tactile impression in the first operation acceptance portion 22.

The reactive force generation mechanism 28 chiefly includes an electric motor drive (that is, a motor) that converts electric energy to rotation energy and a gear that transmits a torque generated in the electric motor drive to the support shaft 24. The reactive force generation mechanism 28 of the present embodiment is configured to generate a force in an opposite direction to a rotation direction of the rotary dial 26 of the first operation acceptance portion 22 and a force in an opposite direction to the tilt direction of the first operation acceptance portion 22.

The reactive force generating mechanism 28 of the present embodiment is of a known configuration as described in, for example, JP 2010-44490 A, the disclosure of which is incorporated herein by reference. A detailed description of the configuration is therefore omitted herein.

The second operation acceptance portion 38 is a panel mechanism including a known touch panel that detects a position the user has touched with his finger and a trajectory of such positions (positional information). The second operation acceptance portion 38 is provided in such a manner that an input screen (an example of an input acceptance mechanism) of the touch panel comes out on a top surface (outer surface) of the rotary dial 26 of the first operation acceptance portion 22. The touch panel forming the second operation acceptance portion 38 of the present embodiment is an example of an internal operation mechanism and a first panel mechanism.

### Control System

The control system 58 of the remote operation device 1 will now be described.

As is shown in FIG. 3, the control system 58 includes a sensor group 60, a controlled subject group 70, and a control portion 75.

The sensor group 60 includes a displacement amount sensor 62, another displacement amount sensor 64, and a rotation amount sensor 66.

The displacement amount sensor 62 measures a tilt direction and a tilt amount (that is, displacement due to tilting) of the first operation acceptance portion 22. The displacement amount sensor 64 measures displacement of the first operation acceptance portion 22 due to pressing. The rotation amount sensor 66 detects a rotation angle (that is, displacement due to a rotation about the axis) of the rotary dial 26 of the first operation acceptance portion 22.

The controlled subject group 70 includes the touch panel 18, the second operation acceptance portion 38, the reactive force generation mechanism 28, and a communication portion 72. The communication portion 72 controls information communications with each in-vehicle device 90 via an in-vehicle network.

The control portion 75 is an electronic control unit (so-called ECU) chiefly including a known computer having at least a ROM 77, a RAM 78, and a CPU 79. The ROM 77 stores processing programs and data, memory contents of which need to be stored even in the event of power shutdown. The RAM 78 temporarily stores processing programs and data. The CPU 79 performs various types of processing according to the processing programs stored in the ROM 77 and the RAM 78.

The ROM 77 stores processing programs for the control portion 75 to perform input acceptance processing, according to which the control portion 75 accepts inputs of information via the input mechanism 20 and the touch panel 18 and operates a specified in-vehicle device 90 by remote control by outputting the accepted information to the specified in-vehicle device 90.

### Input Acceptance Processing

The input acceptance processing performed by the control portion 75 will now be described.

The input acceptance processing is started when an ignition switch is turned ON. Once the input acceptance processing is started, the input acceptance processing is continued by the control portion 75 until the ignition switch is turned OFF.

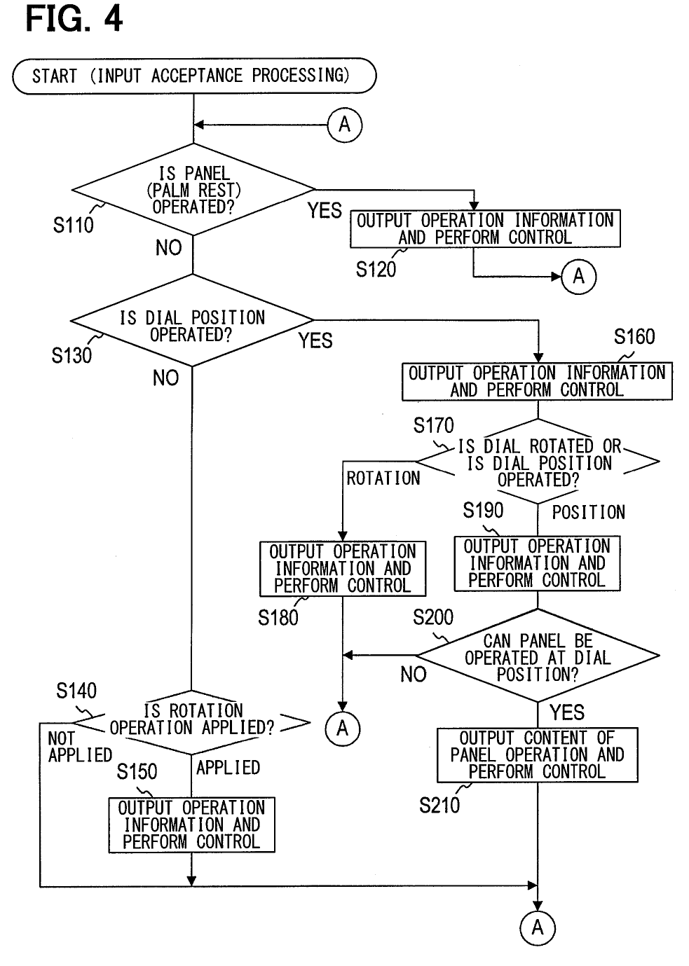

As is shown in FIG. 4, when the input acceptance processing is started, the control portion 75 first determines whether information is inputted via the touch panel 18 (S110). When information is inputted via the touch panel 18 on the basis of a determination result in S110 (S110: YES), the control portion 75 transmits operation information inputted via the touch panel 18 to the in-vehicle device 90 from the communication portion 72 (S120). In other words, in S120 of the present embodiment, the control portion 75 outputs a control command corresponding to an operation on the touch panel 18 to the in-vehicle device 90 via the communication portion 72. Upon acceptance of the control command, the in-vehicle device 90 performs a control according to a content corresponding to the control command.

Subsequently, the control portion 75 returns the input acceptance processing to S110.

On the other hand, when information is not inputted via the touch panel 18 on the basis of a determination result in S110 (S110: NO), the control portion 75 determines whether displacement due to titling is inputted via the first operation acceptance portion 22 (rotary dial 26) (S130). More specifically, the control portion 75 determines in S130 of the present embodiment that displacement due to tilting is inputted via the first operation acceptance portion 22 when a tilt amount detected in the displacement amount sensor 62 is equal to or greater than a predetermined tilt threshold.

When displacement due to tilting is inputted via the first operation acceptance portion 22 on the basis of a determination result in S130 (S130: YES), the control portion 75 advances the input acceptance processing to S160 described in detail below. On the other hand, when displacement due to tilting is not inputted via the first operation acceptance portion 22 on the basis of a determination result in S130 (S130: NO), the control portion 75 determines whether a rotation operation is applied to the first operation acceptance portion 22 (S140). More specifically, the control portion 75 determines in S140 that a rotation operation is applied to the first operation acceptance portion 22 when a rotation angle detected in the rotation amount sensor 66 is equal to or greater than a predetermined angle threshold.

When a rotation operation is applied to the first operation acceptance portion 22 on the basis of a determination result in S140 (S140: APPLIED), the control portion 75 outputs a detection result of the rotation amount sensor 66, that is, “displacement due to a rotation about the axis (to be more exact, a rotation angle of the rotary dial 26 about the z axis as the center of rotation)”, to the in-vehicle device 90 via the communication portion 72 (S150). Upon acceptance of the detection result of the rotation amount sensor 66, the in-vehicle device 90 performs a control corresponding to the rotation operation on the first operation acceptance portion 22.

When the in-vehicle device 90 is, for example, an audio instrument, the phase, “a control corresponding to the rotation operation on the first operation acceptance portion 22”, referred to herein includes a volume adjustment, a selection of radio stations, and a skip of a song that is now playing. When the in-vehicle device 90 is, for example, an in-vehicle air conditioner, the phrase, “a control corresponding to the rotation operation on the first operation acceptance portion 22”, referred to herein includes switching of vents and changing of a pre-set temperature in the vehicle interior.

Subsequently, the control portion 75 returns the input acceptance processing to S110.

When a rotation operation is not applied on the first operation acceptance portion 22 on the basis of a determination result in S140 (S140: NOT APPLIED), the control portion 75 returns the input acceptance processing to S110 without performing S150.

In S160 to which advancement is made when displacement due to tilting is inputted via the first operation acceptance portion 22 on the basis of a determination result in S130 (S130: YES), the control portion 75 outputs a detection result of the displacement amount sensor 62, that is, a tilt direction and a tilt amount of the first operation acceptance portion 22 to the in-vehicle device 90 via the communication portion 72. Upon acceptance of the detection result of the displacement amount sensor 62, the in-vehicle device 90 performs a control corresponding to the tilt direction and the tilt amount of the first operation acceptance portion 22.

The phrase, “a control corresponding to the tilt direction and the tilt amount of the first operation acceptance portion 22”, referred to herein includes a change of the in-vehicle device 90 operated by remote control by the remote operation device 1. The phrase, “a control corresponding to the tilt direction and the tilt amount of the first operation acceptance portion 22”, referred to herein also includes a change of a controlled item among multiple controlled items preliminarily determined for each in-vehicle device 90, and a change of settings in each controlled item.

In the input acceptance processing advanced further, the control portion 75 determines whether the operation applied to the first operation acceptance portion 22 is “displacement due to tilting” or “rotation operation” (S170). When the operation applied to the first operation acceptance portion 22 is a rotation operation on the basis of a determination result in S170 (S170: ROTATION), the control portion 75 outputs a detection result of the rotation amount sensor 66 (that is, a rotation angle of the rotary dial 26 about the z axis as the center of rotation) to the in-vehicle device 90 via the communication portion 72 (S180). Upon acceptance of the detection result of the rotation amount sensor 66, the in-vehicle device 90 performs a control corresponding to the rotation operation on the first operation acceptance portion 22.

When the in-vehicle device 90 is, for example, an in-vehicle air conditioner, the phrase, “a control corresponding to the rotation operation on the first operation acceptance portion 22”, referred to herein includes switching of vents and setting of a temperature in the vehicle interior. When the in-vehicle device 90 is, for example, an audio instrument, the phrase, “a control corresponding to the rotation operation on the first operation acceptance portion 22”, referred to herein includes a volume adjustment, a selection of radio stations, and a skip of a song that is now playing.

Subsequently, the control portion 75 returns the input acceptance processing to S110.

On the other hand, when the operation applied to the first operation acceptance portion 22 is “displacement due to tilting” on the basis of a determination result in S170 (S170: POSITION), the control portion 75 outputs a detection result of the displacement amount sensor 62 (that is, a tilt direction and a tilt amount of the first operation acceptance portion 22) to the in-vehicle device 90 via the communication portion 72. Upon acceptance of the detection result of the displacement amount sensor 62, the in-vehicle device 90 performs a control corresponding to the displacement due to tilting of the first operation acceptance portion 22.

When the control performed earlier in S160 is, for example, a change of the in-vehicle device 90 operated by remote control by the remote operation device 1, the phrase, “a control corresponding to displacement due to tilting of the first operation acceptance portion 22”, referred to herein is a change of a controlled item in the changed in-vehicle device 90. When the control performed earlier in S160 is, for example, a change of a controlled item in the in-vehicle device 90, the phrase, “a control corresponding to displacement due to tilting of the first operation acceptance 22”, referred to herein is a change of settings of the selected controlled item.

In the input acceptance processing advanced further, the control portion 75 determines whether the second operation acceptance portion 38 is at an input acceptable position (S200). The phrase, “the second operation acceptance portion 38 is at an input acceptable position”, referred to herein is used to describe that a relative position of the second operation acceptance potion 38 with respect to the palm rest 10 is a position at which a predetermined condition is satisfied. In the present embodiment, “the predetermined condition” is, for example, that an area of the second operation acceptance portion 38 protruding from the palm rest 10 when the palm rest 10 and the second operation acceptance portion 38 are projected onto the attachment surface (x-y plane) 97 of the attached portion 95 is equal to or greater than a preliminarily determined area.

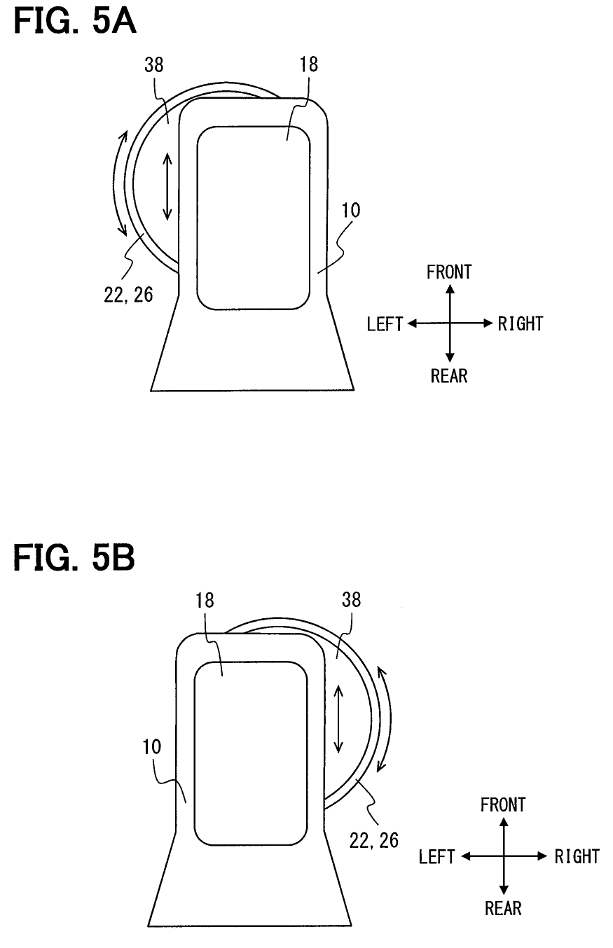

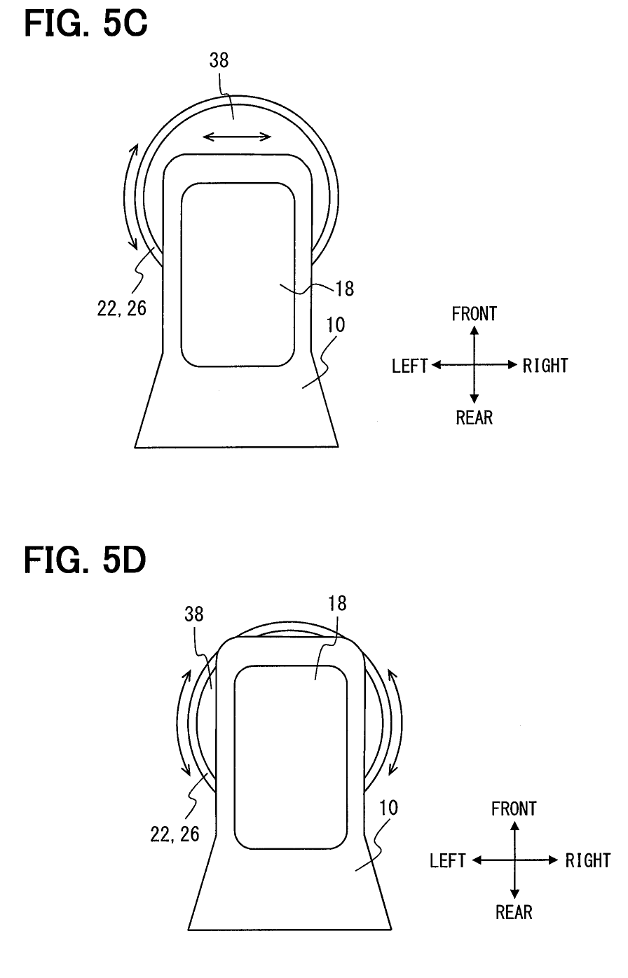

More specifically, the control portion 75 may determine that the second operation acceptance portion 38 is at an input acceptable position, for example, under a condition as shown in FIG. 5A that the first operation acceptance portion 22 is tilted in multiple steps in the left direction and the input screen of the second operation acceptance portion 38 comes out by the predetermined area or more. The control portion 75 may also determine that the second operation acceptance portion 38 is at an input acceptable position, for example, under a condition as shown in FIG. 5B that the first operation acceptance portion 22 is tilted by multiple steps in the right direction. Further, the control portion 75 may determine that the second operation acceptance portion 38 is at an input acceptable position, for example, under a condition as shown in FIG. 5C that the first operation acceptance portion 22 is tilted in multiple steps in the front direction. On the contrary, the control portion 75 may determine that the second operation acceptance portion 38 is at an input unacceptable position, for example, under a condition as shown in FIG. 5D that the first operation acceptance portion 22 is present at the neutral position (that is, at a position not tilted at all).

When the second operation acceptance portion 38 is at an input acceptable position on the basis of a determination result in S200 (S200: YES), the control portion 75 outputs operation information inputted via the second operation acceptance portion 38 to the in-vehicle device 90 from the communication portion 72 (S210). That is to say, in S210 of the present embodiment, the control portion 75 outputs a control command corresponding to the operation applied to the second operation acceptance portion 38 to the in-vehicle device 90 via the communication portion 72. Upon acceptance of the control command, the in-vehicle device 90 performs a control according to a content corresponding to the control command.

When the in-vehicle device 90 is, for example, an in-vehicle navigation system, the phrase, “a control according to a content corresponding to the control command”, referred to herein includes a setting of a destination, scrolling of a displayed map, and zooming in or out of a displayed map.

Regarding “a control according to a content corresponding to the control command”, contents that are different from each other may be preliminarily determined for a control according to the relative position of the second operation acceptance portion 38 with respect to the palm rest 10. For example, when the first operation acceptance portion 22 is tilted leftward, the in-vehicle device 90 as the navigation system may be controlled in response to an input via the second operation acceptance portion 38. Conversely, when the first operation acceptance portion 22 is tilted rightward, the in-vehicle device 90 as the audio instrument may be controlled in response to an input via the second operation acceptance portion 38.

Subsequently, the control portion 75 returns the input acceptance processing to S110.

On the other hand, when the second operation acceptance portion 38 is at an input unacceptable position on the basis of a detection result in S200 (S200: NO), the control portion 75 returns the input acceptance processing to S110 without performing S210.

### Effects of Embodiment

As has been described, according to the remote operation device 1 of the present embodiment, besides “tilting”, “pressing”, and “rotation” of the first operation acceptance portion 22, an input via the second operation acceptance portion 38 and an input via the touch panel 18 are added to information that can be inputted to operate the in-vehicle device 90 by remote control.

Hence, according to the remote operation device 1, input systems of information necessary to operate the in-vehicle device 90 can be increased in comparison with the related art. In short, according to the remote operation device 1, the variety of information that can be inputted can be increased.

In particular, in the remote operation device 1, contents of a control based on information inputted via the second operation acceptance portion 38 can be different from each other according to the relative position of the second operation acceptance portion 38 with respect to the palm rest 10.

Consequently, according to the remote operation device 1, inputs of a wide variety of information can be accepted. Hence, controls with a broad range of contents become available on the in-vehicle device 90.

Hence, according to the remote operation device 1, even when the in-vehicle device 90 is increased in variety or in number, same operations the user has to repeat to operate the respective in-vehicle devices 90 can be reduced. In short, time and labor required for operations can be reduced by the remote operation device 1.

Herein, the remote operation device 1 accepts an input of information via the second operation acceptance portion 38 under the condition that an area of the second operation acceptance portion 38 protruding from the palm rest 10 when the palm rest 10 and the second operation acceptance portion 38 are projected onto the attachment surface (x-y plane) 97 of the attached portion 95 is equal to or greater than predetermined area.

Hence, according to the remote operation device 1, erroneous operations on the second operation acceptance portion 38 can be reduced. Consequently, erroneous operations of the in-vehicle device 90 can be reduced.

### Other Embodiments

While the embodiment of the present disclosure has been described, it should be appreciated that the present disclosure is not limited to the embodiment above and can be implemented in various manners within the scope of the present disclosure.

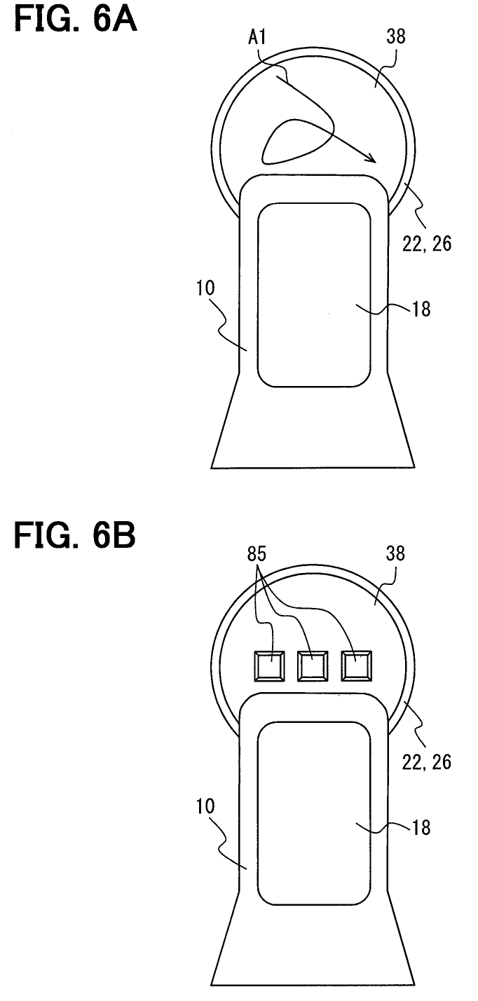

For example, as is shown in FIG. 6A, a second operation acceptance portion 38 of a remote operation device 1 of the present disclosure may accept a trajectory (see an arrow A1) of positions (positional information) a user moved his finger as information used to operate an in-vehicle device 90 by remote control.

According to the remote operation device 1 configured as above, a trajectory of positions (positional information) the user moved his finger, more specifically, a gesture and a character the user inputted with his finger, can be used as information used to operate the in-vehicle device 90 by remote control.

Alternatively, as is shown in FIG. 6B, a second operation acceptance portion 38 of a remote operation device 1 may be provided with at least one mechanical button 85. The buttons 85 are not limited to a mechanical button and may be a button displayed on a touch panel forming the second operation acceptance portion 38.

According to the remote operation device 1 configured as above, information inputted via the button(s) 85 provided to the second operation acceptance portion 38 may be accepted as information used to make settings of the remote operation device 1 and to control an in-vehicle device 90 by remote control.

It is, however, preferable in the present disclosure to provide the buttons 85 to the second operation acceptance portion 38 as shown in FIG. 6B at positions at which the buttons 85 are not covered by a palm rest 10 when a first operation acceptance portion 22 (hence the second operation acceptance portion 38) is tilted in multiple steps in the front direction.

When the buttons 85 are provided as above, a user of the remote operation device 1 is not able to input information via the buttons 85 unless the buttons 85 are at predetermined relative positions with respect to the palm rest 10. Hence, according to the remote operation device 1 configured as above, unwanted operations on the buttons 85 can be reduced and therefore erroneous inputs of information via the buttons 85 can be reduced.

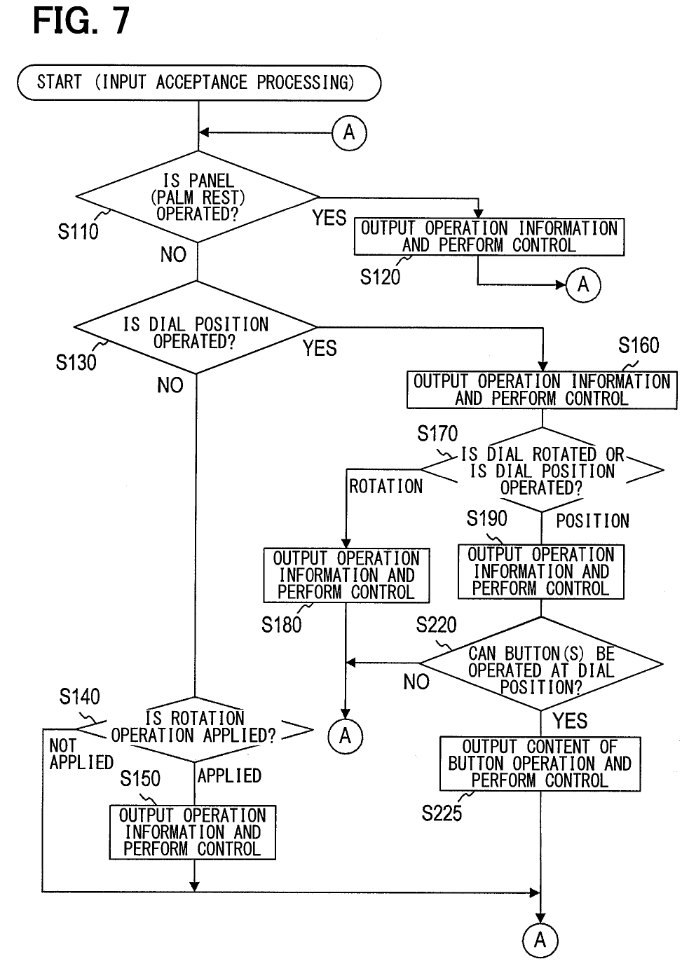

Input acceptance processing that makes such a reduction of erroneous inputs feasible may be configured as shown in FIG. 7. A content of the input acceptance processing shown in FIG. 7 is same as the content described in the embodiment above except for S220 and S225. Hence, S220 and S225 will be described chiefly and a description of the other steps is omitted by labeling the other steps with same step numbers.

In the input acceptance processing shown in FIG. 7, a control portion 75 determines whether the second operation acceptance portion 38 is at a position at which an input of information via the button(s) 85 is acceptable (S220). When the second operation acceptance portion 38 is not at a position at which an input of information via the button(s) 85 is acceptable on the basis of a determination result in S220 (S220: NO), the control portion 75 returns the input acceptance processing to S110. On the other hand, when the second operation acceptance portion 38 is at a position at which an input of information via the button(s) 85 is acceptable on the basis of a determination result in S220 (S220: YES), the control portion 75 transmits the information inputted via the button(s) 85 to the in-vehicle device 90 from a communication portion 72 (S225).

In the present disclosure, diameters of a rotary dial 26 of a first operation acceptance portion 22 and a second operation acceptance portion 38 may be determined in such a manner that areas protruding from a palm rest 10 are equal to or greater than a predetermined area when the first operation acceptance portion 22 is present at a neutral position. In other words, a remote operation device of the present disclosure may be configured in such a manner that an input of information via the second operation acceptance portion 38 is acceptable when the first operation acceptance portion 22 is present at the neutral position.

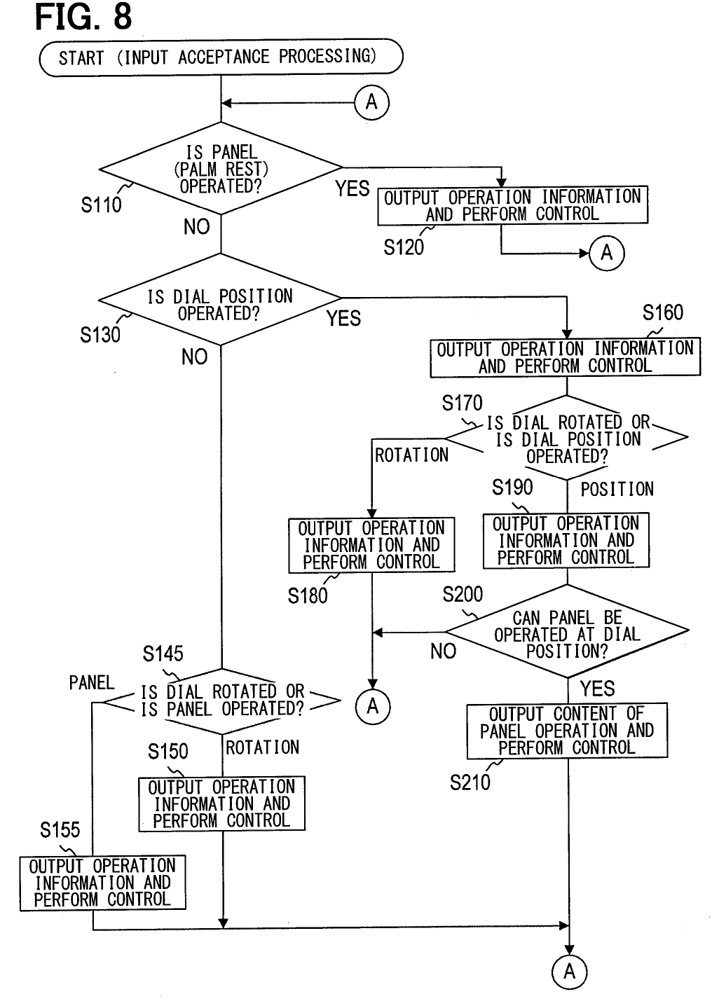

The input acceptance processing to make such an acceptance feasible may be configured as shown in FIG. 8. A content of the input acceptance processing shown in FIG. 8 is same as the content described in the embodiment above except for S145 and S155. Hence, S145 and S155 will be chiefly described and a description of the other steps is omitted by labeling the other steps with same step numbers.

In the input acceptance processing shown in FIG. 8, a control portion 75 determines whether an operation applied on the first operation acceptance portion 22 or the second operation acceptance portion 38 is “a rotation operation” or “an operation on a touch panel” (S145). When the accepted operation is an operation on the second operation acceptance portion 38 (touch panel) on the basis of a determination result in S145 (S145: PANEL), the control portion 75 transmits operation information inputted via the second operation acceptance portion 38 to an in-vehicle device 90 from a communication portion 72 (S155). In S155, the control portion 75 outputs a control command corresponding to the operation applied on the second operation acceptance portion 38 to the in-vehicle device 90 via the communication portion 72. Upon acceptance of the control command, the in-vehicle device 90 performs a control according to a content corresponding to the control command.

On the other hand, in the input acceptance processing shown in FIG. 8, when a rotation operation is applied on the first operation acceptance portion 22 (S145: ROTATION), the control portion 75 outputs a detection result of a rotation amount sensor 66 (that is, a rotation angle of the rotary dial 26 about a z axis as the center of rotation) to the in-vehicle device 90 via the communication portion 72 (S150). Upon acceptance of the detection result of the rotation amount sensor 66, the in-vehicle device 90 performs a control corresponding to the rotation operation on the first operation acceptance portion 22.

According to the remote operation device configured as above, information can be inputted via the second operation acceptance portion 38 without tilting the first operation acceptance portion 22.

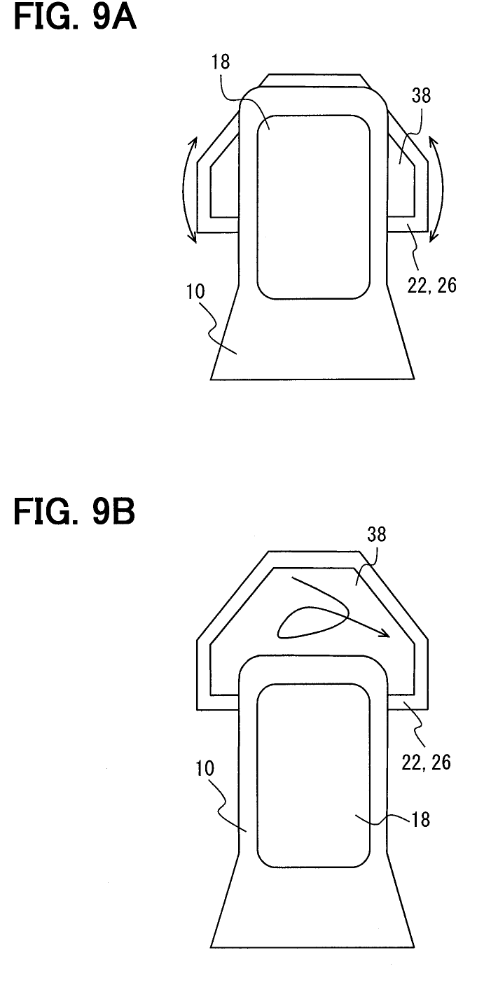

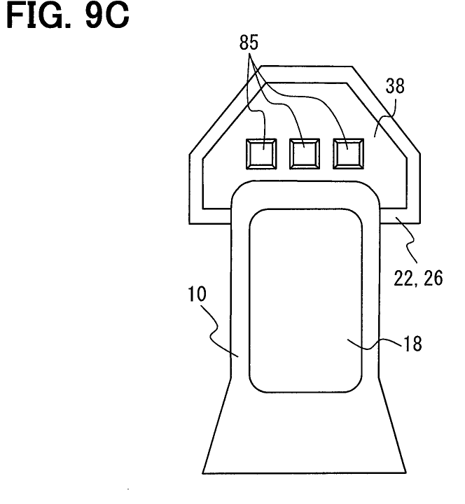

In the embodiment above, the rotary dial 26 of the first operation acceptance portion 22 and the second operation acceptance portion 38 of the remote operation device 1 are of a circular shape. It should be appreciated, however, that shapes of a rotary dial 26 of a first operation acceptance portion 22 and a second operation acceptance portion 38 of the present disclosure are not limited to a circular shape. For example, as is shown in FIG. 9A, the rotary dial 26 of the first operation acceptance portion 22 and the second operation acceptance portion 38 may be of a hexagonal shape. Moreover, the rotary dial 26 of the first operation acceptance portion 22 and the second operation acceptance portion 38 may be of a polygonal shape other than a hexagonal shape, such as a triangular shape, a rectangular shape, a pentagonal shape, and an octagonal shape.

Even when the rotary dial 26 of the first operation acceptance portion 22 and the second operation acceptance portion 38 are formed in a polygonal shape, as is shown FIG. 9B, the second operation acceptance portion 38 of the present disclosure may accept a trajectory of positions (positional information) the user moved his finger as information used to operate an in-vehicle device 90 by remote control.

Also, even when the rotary dial 26 of the first operation acceptance portion 22 and the second operation acceptance portion 38 are formed in a polygonal shape, as is shown in FIG. 9C, the second operation acceptance portion 38 of the present disclosure may be provided with at least one button 85. The remote operation device configured as above may accept information inputted via the button(s) 85 provided to the second operation acceptance portion 38 as information used to make settings of the remote operation device and to operate the in-vehicle device 90 by remote control.

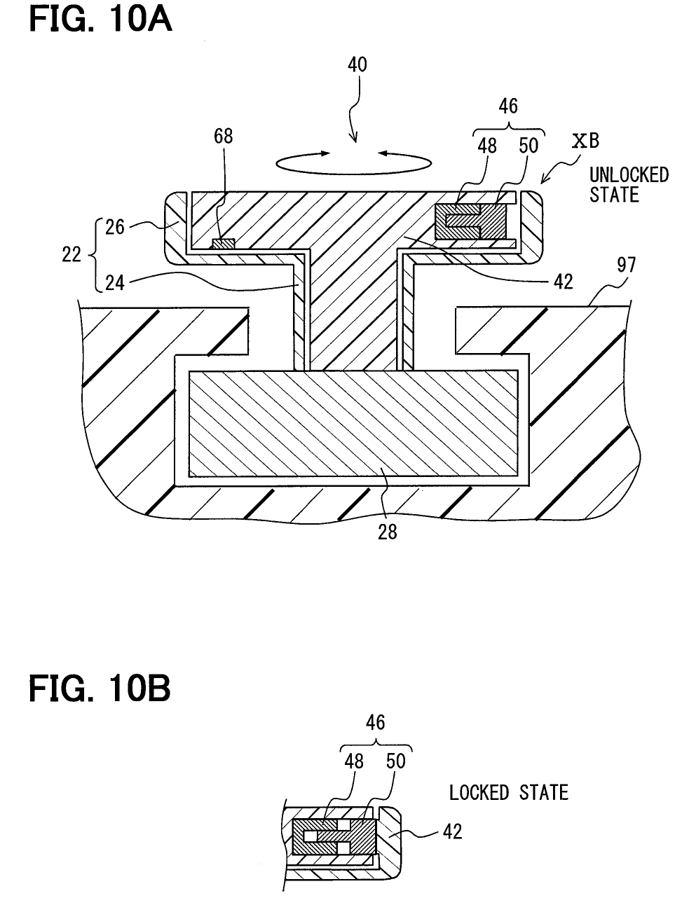

The second operation acceptance portion 38 in the embodiment above is formed of the touch panel. However, the second operation acceptance portion 38 is not limited to a touch panel. As are shown in FIG. 10A and FIG. 10B, a second operation acceptance portion 40 may chiefly include a rotatable rotary disc 42 provided separately from a first operation acceptance portion 22 in an inner periphery of a rotary dial 26 on the condition that the second rotation acceptance portion 40 is formed in such a manner that information different from information inputted to the first operation acceptance portion 22 can be inputted. It is preferable that the rotary disc 42 is formed of a circular disc axially supported on the first operation acceptance portion 22 without making contact with the first operation acceptance portion 22 and is thus allowed to rotate separately from the first operation acceptance portion 22.

Further, the second operation acceptance portion 40 as above may be configured to be switched between a locked state (see FIG. 10B) in which the second operation acceptance portion 40 is locked with the first operation acceptance portion 22 and therefore rotates integrally with the first operation acceptance portion 22 and a unlocked state (see FIG. 10A) in which the second operation acceptance portion 40 is released from the locked state and therefore rotates separately from the first operation acceptance portion 22 by a solenoid 46 including a coil 48 and a movable iron core 50.

Furthermore, in the embodiment above, the remote operation device 1 is installed on the console between the driver's seat and the front passenger's seat in the vehicle interior. However, the remote operation device 1 is not necessarily installed on the console specified above. The remote operation device 1 may be installed, for example, on a door trim of an automobile or on a console provided in back seats of an automobile.

In the embodiment above, the remote operation device 1 is installed to an automobile. However, the remote operation device 1 is not necessarily installed to an automobile. For example, the remote operation device 1 may be installed to a train, an air plane, and a marine vessel. In short, the remote operation device 1 may be installed to any type of mobile body.

While the embodiments of the present disclosure have been described, it should be appreciated that the present disclosure includes the embodiments above even when a part of the configurations are omitted to the extent that the problems can be solved. The present disclosure also includes any combination of the above embodiments and modifications. The present disclosure further includes any form conceivable within the scope of the disclosure specified by the languages of the appended claims.

The flowcharts and processing in the flowcharts described herein are formed of multiple sections (or referred to as steps). Each section is referred to as, for example, S100. Each section may be divided to two or more sub-sections. Conversely, multiple sections may be combined into a single section. The respective sections formed as above may be referred to also as devices, modules, means, or portions.

What is claimed is:

1. A remote operation device attached to an attached portion, which is a predetermined portion of a mobile body, and configured to operate an installed device installed to the mobile body by remote control, the remote operation device comprising:
an operation acceptance portion provided as a mechanism to accept an operation from an outside and having a rotary disc supported in a displaceable and rotatable manner;
a palm rest portion extending from the attached portion so as to cover at least a part of the rotary disc; and
a control portion transmitting information corresponding to an operation from the outside and accepted in the operation acceptance portion to at least the installed device,
wherein the operation acceptance portion includes:
an internal operation mechanism having an input acceptance mechanism provided on an outer surface of the rotary disc;
a first input portion accepting displacement of the rotary disc from a preliminarily determined neutral position as one operation from the outside;
a second input portion accepting a rotation angle of the rotary disc as one operation from the outside; and
a third input portion accepting an operation on the internal operation mechanism as one operation from the outside.

2. The remote operation device according to claim 1, wherein:
the internal operation mechanism is a first panel mechanism including a touch panel.

3. The remote operation device according to claim 2, wherein:
the control portion transmits a trajectory of positional information on the first panel mechanism to the installed device.

4. The remote operation device according to claim 2, wherein:
the third input portion accepts an input of information via the first panel mechanism when a relative position of the internal operation mechanism with respect to the palm rest portion is a position at which a predetermined condition is satisfied.

5. The remote operation device according to claim 1, wherein:
the internal operation mechanism is provided with a button which comes out so as to accept an operation from the outside when the relative position of the internal operation mechanism with respect to the palm rest portion is a predetermined position.

6. The remote operation device according to claim 1, wherein:
the palm rest portion is provided with a second panel mechanism including a touch panel different from the first panel mechanism; and
the operation acceptance portion includes a fourth input portion accepting an input via the second panel mechanism as one operation from the outside.

7. The remote operation device according to claim 1, wherein:
the control portion transmits a displacement amount of the rotary disc from the neutral position and a position of the rotary disc both accepted in the first input portion to the installed device.

8. The remote operation device according to claim 1, wherein:
the internal operation mechanism is an input mechanism in which a part of the rotary disc is formed to be rotatable separately from the entire rotary disc; and
the third input portion accepts a rotation operation on the internal operation mechanism as one operation from the outside.
